(19) United States
(12) Patent Application Publication
(10) Pub. No.: US 2009/0309346 A1
(43) Pub. Date: Dec. 17, 2009

(54) Intelligent Vehicle Safety Restraint System

(75) Inventors: Charles Van Druff, Laguna Hills, CA (US); Christopher Culbertson, Irvine, CA (US)

Correspondence Address: INSKEEP INTELLECTUAL PROPERTY GROUP, INC, 2281 W. 190TH STREET, SUITE 200, TORRANCE, CA, 90504, US

(73) Assignee: MillenWorks

(21) Appl. No.: 12/484,970

(22) Filed: Jun. 15, 2009

Related U.S. Application Data
(60) Provisional application No. 61/061,332, filed on Jun. 13, 2008.

(51) Int. Cl. B60R 22/46

(52) U.S. Cl. 280/806

(57) ABSTRACT

A resettable combat vehicle restraint system prevents secondary impacts within the vehicle cabin during crash, mine blast, or rollover events by positioning the occupant within a load attenuating seat to best survive the dangerous event. The preferred embodiment of the restraint system includes a five point restraint, webbing retractors for each lap and shoulder belt with the capability for both reversible and pyrotechnic pretensioning, an active headrest, and a crash recognition module to electrically activate the pyrotechnic pretensioners and to electrically modulate the actions of the reversible pretensioning retractors and the active headrest.

### RELATED APPLICATIONS

This application claims priority to U.S. Provisional Application Ser. No. 61/061,332 filed Jun. 13, 2008 entitled Resettable Safety System for Upgraded Occupant Survivability, the contents of which are incorporated in their entirety herein.

### BACKGROUND OF THE INVENTION

The present invention generally relates to the protection of military vehicle occupants from the high forces encountered during a crash event, specifically from secondary impacts within the vehicle.

In automobiles, crash energy mitigation has focused on protection of occupants through passive occupant restraints and by limiting secondary impact forces using load-attenuating deformable structures such as padded dashboards, collapsible steering columns, and airbags. This approach has dramatically reduced both serious and fatal injuries in the modern automobile.

Unfortunately, deformable structures are less applicable to military aircraft and ground vehicles. The large volume of vehicle controls and mission-related equipment located in the cabins of these vehicles make it impossible to surround the occupants with deformable structure. The occupants of these vehicles are also exposed to rapid vertical accelerations which are not present in automobiles, further complicating the protection of these occupants from secondary impacts within the vehicle. In the case of military aircraft, these vertical accelerations result from the crash event itself, while ground vehicles are subjected to these accelerations by anti-vehicle mines or other explosive devices encountered in combat.

To counter the effects of rapid vertical accelerations on the occupant's spine, vertically stroking seats are used in both military ground and air vehicles. While this approach reduces spinal injuries, the vertical motion of the seat makes the occupant more likely to strike other objects within the vehicle cabin.

During a crash, mine blast or rollover event, the seat and restraint are designed to protect a fully upright occupant whose upper torso is resting against the seat back. In the moments immediately before many crash or blast events, occupants are diligently taking measures to prevent their vehicle from crashing or performing their normal duties within the vehicle.

While performing these tasks the occupant's body position can deviate significantly from the most survivable orientation. The occupant's body can further deviate due to maneuver loads. At the moment of impact, the vehicle can permanently deform and absorb the crash- or blast-related kinetic energy. This deceleration causes the occupant to move and slump in his seat.

As the crash proceeds the occupant will accelerate forward relative to the seat. This increases the tension on the restraint's shoulder straps, causing the webbing to pack down within the shoulder harness retractor and stretch, effectively loosening the restraint and causing the occupant's upper torso and head to rotate forward into close proximity with hard structures within the vehicle. This combination of slump and rotation can be aggravated by some crashworthy designs that allow continued head and body travel as part of the load attenuation process. The slump, rotation and energy attenuation makes secondary cabin impacts more likely and, in vehicles with small cabins, can even result in the occupant's head or body protruding through the vehicle window or door.

### SUMMARY OF THE INVENTION

In a preferred embodiment, the present invention limits secondary impacts within the vehicle cabin in two ways: first, it prepares the occupant for a crash or blast event prior to the moment of impact, and second it limits an occupant's movement relative to the seat after the blast or crash event has begun. These actions are preferably achieved with a restraint system that monitors sensor data and adjusts the restraint on the occupant accordingly. Generally, this monitoring and adjusting is achieved with an active restraint system, an active headrest, and a crash recognition module (CRM).

Preferably, the active restraint includes two lap belts (also known as straps or webbing), two shoulder belts, and a tie-down strap attached to a rotary buckle. Attached to each lap and shoulder strap is a webbing retractor with an integral pyrotechnic pretensioner, a reversible pretensioner, and a spool position encoder. The reversible and resettable nature of the reversible pretensioners greatly increase the ability of the restraint to keep the occupant in a safe and survivable orientation without interfering with their duties. The pyrotechnic pretensioner allows for quicker retraction and therefore can be activated after a crash has begun. In this respect, the combined use of both the reversible electric pretensioner and the pyrotechnic pretensioner provides the best attributes of both devices in a single retractor.

When the occupant buckles the restraint, sensors within the buckle allow the CRM to determine that the restraint is fully donned. The CRM establishes a baseline position for each retractor's webbing spool which is stored by the CRM until the restraint is unbuckled. Each retractor repeatedly samples the spool position and communicates the position to the CRM.

When a shoulder strap is extended significantly beyond the baseline position for any length of time, the occupant is reminded to sit up straight by a gentle, haptic, “out of position” tug on the shoulder strap caused by momentarily energizing the retractor's reversible pretensioning motor. If the CRM's predictive algorithms determine that the vehicle is maneuvering aggressively or erratically, each retractor's reversible pretensioner is energized to supplement the passive spring retraction force and eliminate slack from the shoulder and lap straps. The elimination of belt slack significantly reduces occupant slump and rotation during a blast or crash event. Additionally, keeping the occupant upright and close to the seat back during aggressive maneuvers may improve his or her ability to maintain control of the vehicle.

If a crash does not occur and the vehicle resumes a more stable operation, the CRM de-energizes each retractor's reversible pretensioner to relax the straps back to their baseline positions and allow the occupant to pay out additional strap. Once the CRM determines that a crash or blast event is occurring, it activates the pyrotechnic pretensioners in each retractor. This holds the occupant firmly upright in the seat, compensating for any packdown inside of the retractor and for webbing stretch due to increasing belt forces, limiting both torso rotation and lateral movement of the occupant.

While the shoulder strap pretensioners are effective at controlling lateral torso motion, the occupant's head can still experience enough lateral motion to cause a secondary impact with a side window or other primary structure, especially in vehicles with small cabins. To effectively control this, an active headrest is used in the preferred embodiment of this invention. To avoid limiting the occupant's field of vision during routine vehicle operation, the lateral supports are stowed in an aft or retracted position.

When a crash event is likely to occur, the CRM pivots the lateral supports of the active headrest forward. The lateral supports include deformable padding to limit the maximum impact force imparted to the occupant's head. The spring-biased lateral supports ratchet forward, limiting the travel of the occupant's head and providing a cushioned lateral impact surface. If the vehicle returns to a stable mode of operation the lateral supports are electrically retracted to their stowed position after a reasonable delay, restoring the occupant's field of view and resetting the headrest for a future crash or aggressive maneuver event.

In addition to assessing an occupant's position within his or her seat, the CRM contains an inertial monitoring unit consisting of multi-axis accelerometers (e.g., X, Y and Z dimensions) and rate gyros (e.g., roll, pitch and yaw) to determine vehicle rotational and linear acceleration rates. Algorithms running on the CRM analyze the sensor data and determine that the vehicle is in one of three operating states: stable operation, aggressive maneuvering, or crashing.

During stable vehicle operation the CRM simply monitors the retractors for excessive deviations from their baseline strap positions, issuing haptic “out of position” warnings if necessary. If the vehicle is maneuvering aggressively, the CRM activates the resettable features of the present invention, deploying the active headrest and commanding the reversible pretensioner in each retractor to remove slack from each lap and shoulder strap. Some of the conditions that determine this state include excessive yaw rates, combined pitch and roll angles that are excessive, and sustained acceleration rates above a preset G level.

After the CRM determines that the vehicle is once again in stable operation, it commands the retractors to return to baseline position and the headrest to retract its lateral supports. If at any time the algorithms determine that a crash is occurring, the CRM deploys the active headrest (if it is currently stowed) and sends a firing signal to each retractor pretensioner, causing it to retract additional webbing within 50 milliseconds of activation. The quick reaction time can be especially achieved with the pyrotechnic pretensioner which is ignited by electrical energy above a threshold value. The electrical energy is stored in a capacitor bank inside the CRM and released by closing a switch.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which:

FIG. 1A is an isometric view of a preferred embodiment of a vehicle restraint system according to the present invention;

FIG. 1B illustrates a magnified view of a buckle from FIG. 1B;

FIG. 2 is an isometric rear view of the embodiment of FIG. 1A;

FIG. 3 is an exploded view of a rotary buckle according to a preferred embodiment of the present invention;

FIG. 4A is a detailed top view of an active headrest in the stowed orientation according to the present invention;

FIG. 4B is a detailed top view of the active headrest of FIG. 4A in the deployed orientation;

FIG. 5 is a detailed exploded view of the active headrest in the stowed orientation according to the present invention;

FIG. 6 is a schematic representation of a crash recognition module according to the present invention; and,

FIG. 7 is a system flow diagram of restraint system behavior according to the present invention.

### DESCRIPTION OF EMBODIMENTS

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

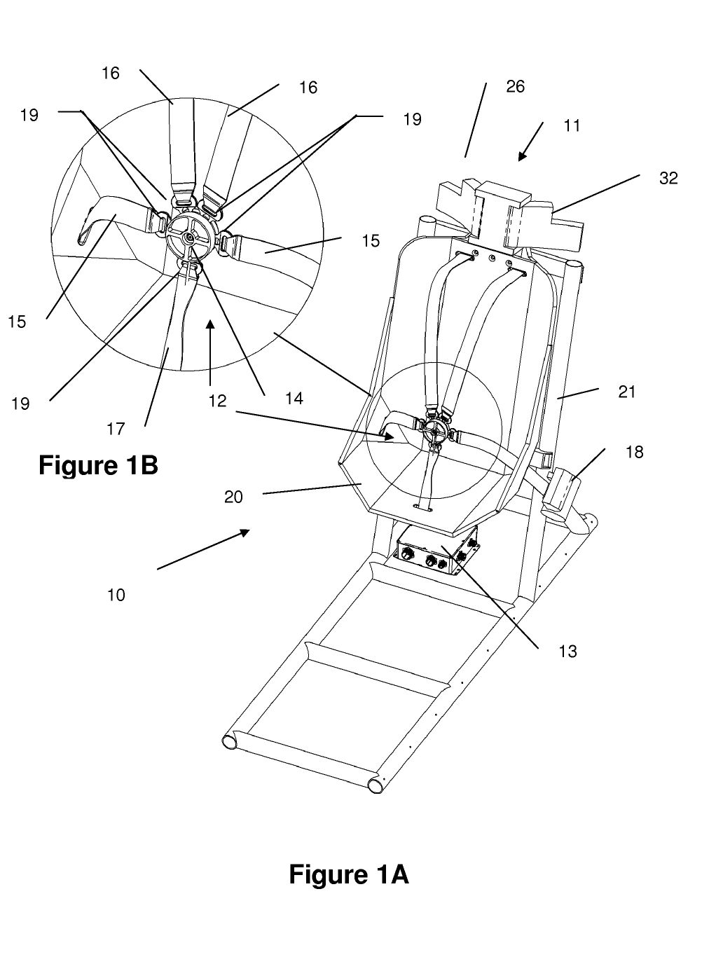

FIG. 1A illustrates a preferred embodiment of a resettable combat vehicle restraint system 10 that secures an occupant within a vehicle. In addition to simply maintaining the position of the occupant, the vehicle restraint system 10 prepares the occupant for a crash or extreme movement and limits the occupant's movement after the crash event has begun. Hence, the occupant is better protected from injuries.

The resettable combat vehicle restraint system 10 preferably includes an active five-point restraint 12 and an active headrest 11 for actively restraining an occupant's body. A crash recognition module (CRM) 13 monitors sensor data from the active five-point restraint 12 and active headrest 11 and appropriately controls the behavior of each.

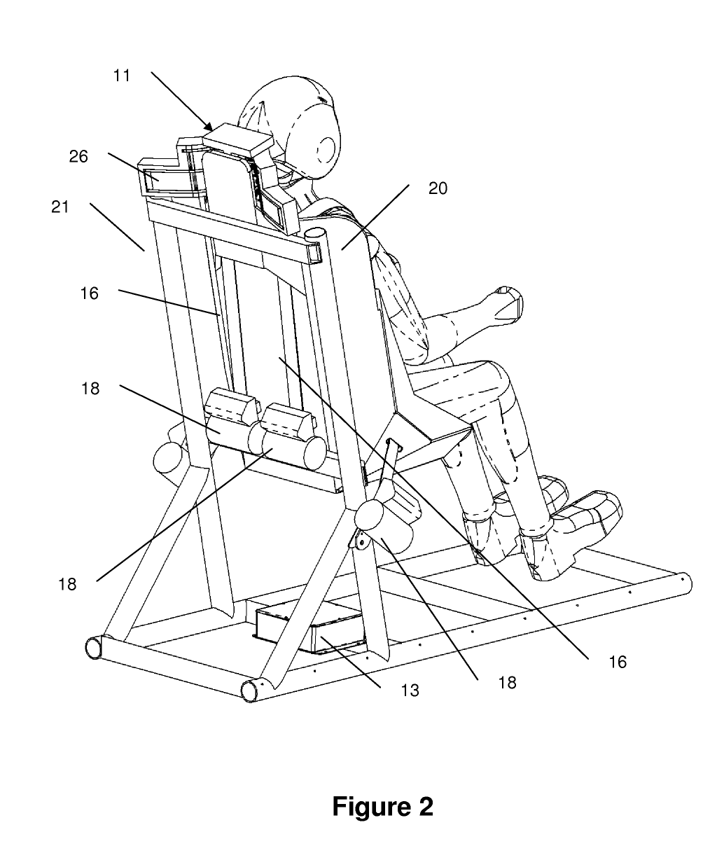

The active five-point restraint 12, best seen in FIGS. 1A, 1B and 2, preferably includes two lap straps 15 that are arranged to extend over the occupant's lap, two shoulder straps 16 arranged to extend over the occupant's shoulders and a tie-down strap 17 arranged to extend between the occupant's legs. An example of such a strap arrangement can be seen in U.S. Pat. Nos. 6,367,882 and 4,967,985, the contents of which are hereby incorporated by reference.

The lap straps 15 and shoulder straps 16 are each coupled to a retractor 18 that winds the straps 15 and 16 around a spool. The retractor 18 includes a mechanical, reversible pretensioner that provides a rotational bias to the winding spool and further locks movement of the spool during rapid unwinding of the spool (i.e., sudden pull out of the strap). Additionally, the reversible pretensioner includes a motor for electrically winding the spool at a desired time. Examples of reversible pretensioners can be seen in U.S. Pat. Nos. 5,765,774; 5,558,370; 5,076,609; and 5,005,777; the contents of which are hereby incorporated by reference.

Additionally, an integral pyrotechnic pretensioner is included in the retractor 18 to provide electronic control of locking and winding of the spool more quickly than the electronic reversible pretensioner. Hence, the pyrotechnic pretensioner is better suited to causing retraction after a crash has begun. Examples of integral pyrotechnic pretensioners can be seen in U.S. Pat. Nos. 5,443,222 and 5,415,431; the contents of which are hereby incorporated by reference.

The rotation position of the spool of each retractor 18 is monitored with a sensor, such as a rotary position encoder. Examples of such position encoders can be seen in U.S. Pat. Nos. 4,819,051; 4,567,467 and 5,736,865; the contents of which are hereby incorporated by reference.

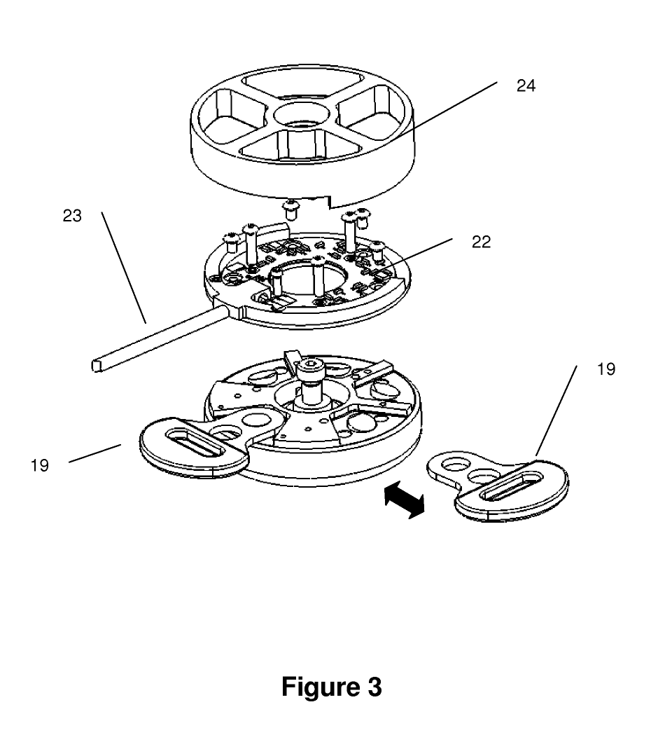

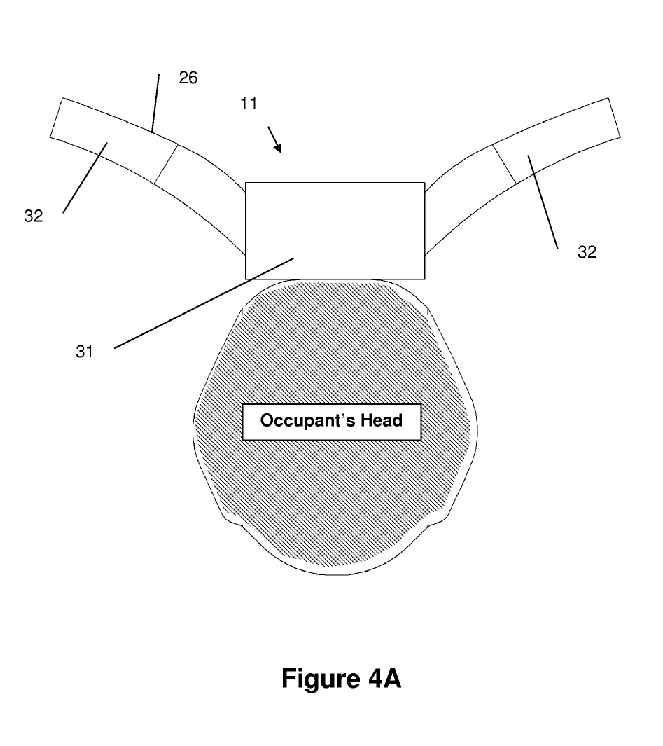

As seen in FIGS. 1B and 3, each of the five straps 15, 16 and 17 has an end fitting 19 attached to its free end to interlock with rotary buckle 14. Preferably at least one of the end fittings 19 are nonremovably connected to the rotary buckle 14, such as on the tie-down strap 17 or to either lap strap 15 of five-point restraint 12.

The rotary buckle 14 detects when the user buckles the straps 15, 16 and 17 and communicates this information to the crash recognition module 13. As seen in FIG. 3, at least one sensor 22 is included to detect the insertion of the end fitting 19 into the rotary buckle 14. Sensor 22 can be of a hall-effect type, a proximity switch type, optical, or any other technology to sense the presence or absence of end fitting 19.

When all four of the removable end fittings 19 are inserted into rotary buckle 14, electrical data signals are communicated through a buckle wire harness 23 which is connected to the CRM 13. The seat occupant can release the five-point restraint 12 by rotating the cover 24 of the rotary buckle 14, disengaging the four non-permanently attached end fittings 19 and thereby allowing each of the four retractors 18 to retract each lap strap 15 and shoulder strap 16.

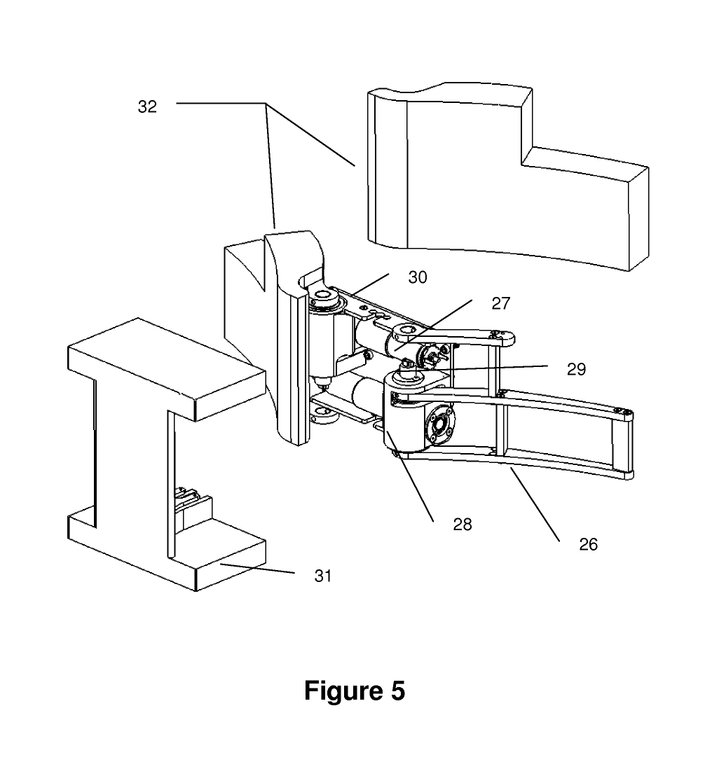

During a crash or extreme maneuver, the occupant's head can still experience enough lateral motion to cause a secondary impact with a side window or other primary structure. To reduce the effects of these forces, the active headrest 11 (seen best in FIGS. 1A, 2, 4A, 4B and 5) includes two lateral supports 26 with deformable padding 32 disposed over at least a front surface (i.e., facing out and towards an occupant) to limit the impact force imparted to the occupant's head.

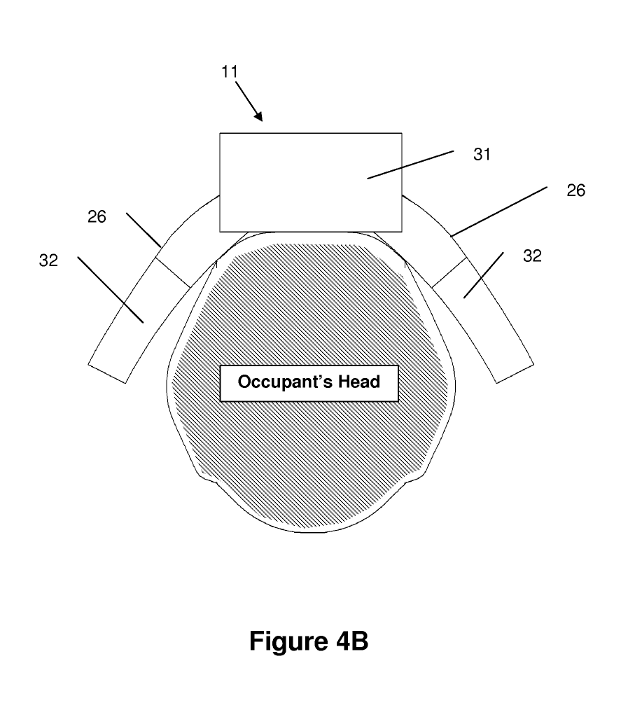

When a crash event is likely to occur, the CRM 13 pivots the lateral supports 26 forward on each side of the occupant's head (e.g. as seen in FIG. 4B). If the vehicle returns to a stable mode of operation, the lateral supports 26 are electrically retracted to their stowed position (e.g., FIG. 4A) after a predetermined delay, restoring the occupant's field of view and resetting the headrest 11 for a future crash or aggressive maneuver event.

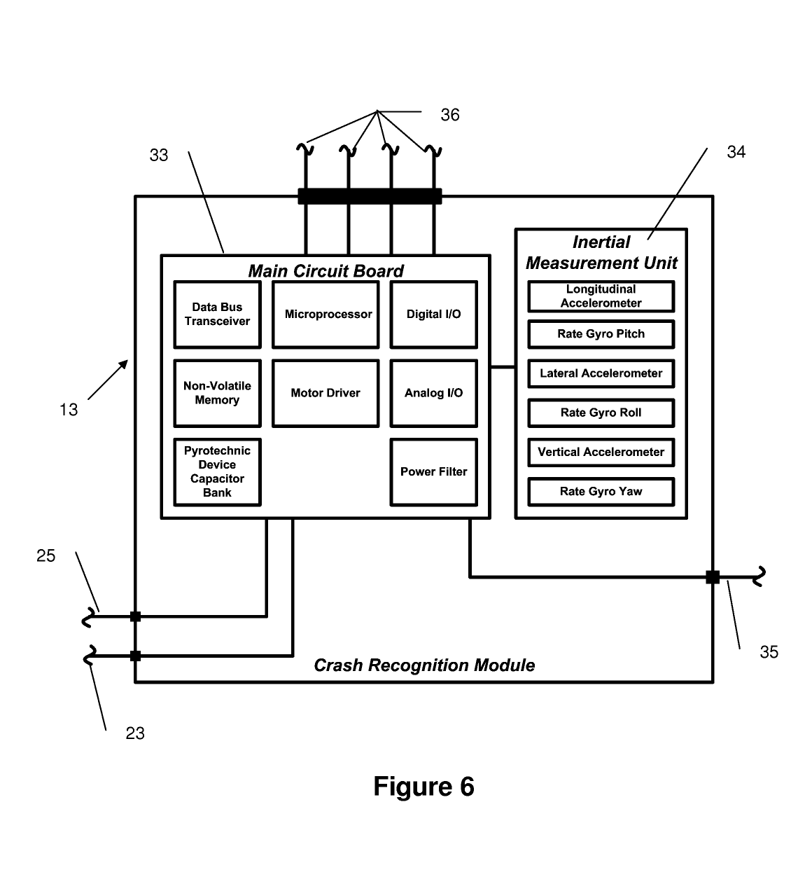

The active headrest 11 is mounted to the top of the bucket 20 and connected to the CRM 13 by a headrest wire harness (see FIG. 6). Preferably, the active headrest 11 consists of at least one lateral support 26 that is pivotally mounted on a frame 30. An electric motor 27 is coupled to the frame 30 and a reduction gearset 28, allowing the motor 27 to drive movement of the gearset 28. The gearset 28 is further coupled to the lateral supports 26, selectively moving their position between the normal, retracted position (FIG. 4A) and the forward, crash position (FIG. 4B). The position of the lateral supports 26 can be determined by a sensor such position encode 29. In this respect, the CRM 13 can monitor the position of the headrest 11 and change the position of the lateral supports 26 at an appropriate time.

Generally, the CRM 13 monitors sensors that provide data on the occupant (e.g., the rotary position encoder of the retractor 18 and the buckle sensor 22) and data on the movement of the vehicle. The CRM 13 uses this data to determine how the straps 15, 16 and active headset 11 should be adjusted at any given time.

As seen in FIG. 6, the CRM 13 includes a main circuit board 33 that receives sensor data, processes the data with algorithms, and controls the restraint system 10. Sensor data from the retractors 18 and active headrest 11 is communicated to the main circuit board 33 over a retractor wire harness 36 and headrest wire harness 25, respectively.

Preferably, a power/vehicle bus connector 35 can also be connected to the main circuit board 33 to provide sensor data from the vehicle (e.g., speed, ground proximity, external air pressure, engine speed, antilock braking system activation) and power for operation. This vehicle sensor data can be used in conjunction with other sensor data to determine behavior of the restraint system 10. However, the CRM 13 may operate in a “stand alone” mode without this vehicle sensor data. Note that the types of sensor data will vary between vehicle types. For example, antilock braking systems may be specific to ground vehicles while external air pressure may be specific to aerial vehicles.

The main circuit board 33 is also in communication with an inertial measurement unit 34 which provides information on the movement of the vehicle. Preferably, the inertial measurement unit 34 includes a longitudinal accelerometer for providing longitudinal acceleration data, a rate gyro pitch sensor for providing vehicle pitch data, a lateral accelerometer for providing lateral acceleration data, a rate gyro roll sensor for providing vehicle roll data, a vertical accelerometer for providing vertical acceleration data and a rate gyro yaw sensor for providing vehicle yaw data. In other words, these sensors provide the main circuit board 33 with data on how the vehicle is moving in three dimensions.

The main circuit board 33 accepts the sensor data through various analog or digital inputs and stores this data (at least temporarily) in non-volatile memory over a data bus. A microprocessor on the main circuit board 33 executes a plurality of algorithms on this data to determine the desired behavior of the restrain system 10. Example algorithms include crash/blast detection algorithms, aggressive maneuver detection algorithms, and occupant out-of-position (OOP) algorithms based on the sensor data. In a more specific example, the crash/blast algorithm can be watch for either roll, pitch, or yaw exceeding threshold values, accelerations exceeding threshold values, freefall (vertical accelerations equal to gravity) or any combination of the above. In another more specific example, the out-of-position algorithm can watch for belt payout exceeding a nominal value above a baseline value.

Preferably these algorithms use at least some of the sensor data from vehicle accelerations and angular rates from inertial measurement unit 34, the spool position of each retractor 18, the connection status of each removable end fitting 19 into rotary buckle 14 and the position of each lateral support 26 contained in active headrest 11.

When the occupant buckles the straps 15 and 16, the CRM 13 receives data from sensors 22 within the buckle 14 and determines that the occupant is buckled in. The CRM 13 then establishes a “baseline position” (e.g., a normal, stationary position) for each webbing spool of the retractors 18. This baseline position is stored until the CRM 13 detects that the straps 15 and 16 are unbuckled.

When a strap 15 or 16 is extended significantly beyond the baseline position for a predetermined length of time (e.g., 30 seconds), the CRM 13 reminds the occupant to sit up straight by a gentle, haptic, “out of position” tug on the strap 15 or 16 caused by momentarily energizing pretensioning motor of the retractor 18. Since moving away from the normal sitting or standing position reduces the ability of the restraint system 10 to protect the occupant, this tug reminds the user to quickly return to their baseline position.

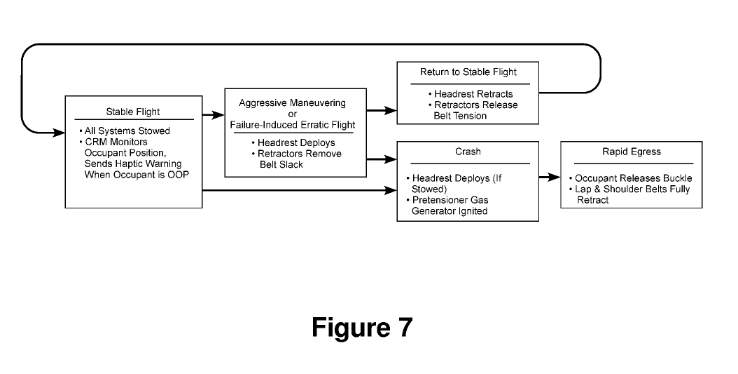

FIG. 7 illustrates a flow chart showing a preferred behavior of the restraint system 10 during different vehicle operation situations. During stable flight, the active headrest 11 remains in a retracted position, the retractors 18 allow the straps 15 and 16 to unwind and the CRM 13 sends haptic warning tugs when the user is out of the established baseline position.

If predictive algorithms within the CRM 13 determine that the vehicle is maneuvering aggressively or erratically, each reversible pretensioner in the retractors 18 is energized to supplement the passive spring retraction force and eliminate slack from the shoulder and lap straps. The elimination of belt slack significantly reduces occupant slump and rotation during a blast or crash event. Additionally, keeping the occupant upright and close to the seat back during aggressive maneuvers may improve his or her ability to maintain control of the vehicle. The CRM 13 also deploys the two lateral supports 26 of the active headrest 11 to provide support and protection to the occupant's head.

If a crash does not occur after a predetermined period of time and the vehicle resumes a more stable operation, the CRM 13 de-energizes each retractor's reversible pretensioner to relax the straps back to their baseline positions and allow the occupant to pay out additional strap. The CRM 13 continues monitoring data for aggressive maneuvering or crash conditions.

If the CRM 13 determines that a crash or blast event is occurring, it activates the pyrotechnic pretensioners (by igniting a gas generator) in each retractor 18 and removes all slack in the straps 15 and 16, preferably within about 50 milliseconds. This holds the occupant firmly upright in the seat, compensating for any packdown inside of the retractor and for webbing/strap stretch due to increasing belt forces, limiting both torso rotation and lateral movement of the occupant. If the lateral supports 26 of the headrest 11 have not already been deployed (e.g., triggered by an aggressive maneuvering algorithm), then they are deployed.

Once a crash has occurred, the occupant releases the buckle 14, allowing the straps 15 and 16 to be fully retracted. The occupant can then quickly egress from the restraint system 10 and the vehicle.

It should be understood that in another preferred embodiment, the previously described active headrest may not be appropriate or necessary. For example, some (but not all) ground or air vehicle types may only see marginal safety benefit from the headrest and therefore may not be cost or weight effective.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An occupant restraint system comprising;
a crash recognition module comprising a microprocessor and an inertial measurement unit;
a motorized retractor in communication with said crash recognition module; and,
at least one restraint strap sized to restrain an occupant and retractably disposed on said motorized retractor;
wherein said crash recognition module adjusts a retraction state of said motorized retractor based on inertial data from said inertial measurement unit.

2. The occupant restraint system of claim 1, wherein said at least one restraint strap and said motorized retractor is part of an active five-point restraint.

3. The occupant restraint system of claim 1, wherein said inertial measurement unit comprises at least one multi-axis accelerometer and at least one rate gyro.

4. The occupant restraint system of claim 3, wherein said inertial data comprises vehicle rotational and linear acceleration rates.

5. The occupant restraint system of claim 1, wherein said motorized retractor further comprises a spool sensor arranged to determine a rotational position of a spool of said motorized retractor; said spool sensor in communication with said crash recognition module.

6. The occupant restraint system of claim 5, further comprising a buckle arranged for securing said restraint strap; said buckle comprising a buckle sensor in communication with said crash recognition module and arranged to detect buckling of said restraint strap.

7. The occupant restraint system of claim 6, wherein said crash recognition module determines a baseline restraint strap position based on data from said buckle sensor and said spool sensor.

8. The occupant restraint system of claim 7, wherein said crash recognition module is programmed to momentarily energize said motorized retractor to provide a haptic movement when said spool is extended beyond said baseline restraint strap position.

9. The occupant restraint system of claim 7, wherein said crash recognition module determines a crash is occurring and retracts said at least one restraint strap past said baseline restrain strap position.

10. The occupant restraint system of claim 1, further comprising an active headrest in communication with said crash recognition module.

11. The occupant restraint system of claim 10, wherein said active headrest comprises a first motorized lateral support and a second motorized lateral support.

12. An occupant restraint system comprising:
a first electrically controllable retractor having a first spool position sensor and a first electrically controllable pretensioner; said first electrically controllable retractor being fixed within a vehicle;
a second electrically controllable retractor having a second spool position sensor and a second electrically controllable pretensioner; said second electrically controllable retractor being fixed within said vehicle;
a buckle;
a lap strap coupled to said first electrically controllable retractor and selectively engageable with said buckle;
a shoulder strap coupled to said second electrically controllable retractor and selectively engageable with said buckle;
an inertial measurement unit comprising sensors for measuring acceleration of a vehicle along a longitudinal, lateral and vertical axis; and,
a microprocessor in communication with said first spool position sensor, said second position sensor, said first electrically controllable pretensioner and said second electrically controllable pretensioner;
wherein said microprocessor is configured to retract said first electrically controllable pretensioner and said second electrically controllable pretensioner based on longitudinal, lateral and vertical axis acceleration data.

13. The occupant restraint system of claim 12, wherein said inertial measurement unit further measures roll, pitch and yaw and wherein said microprocessor is configured to retract said first electrically controllable pretensioner and said second electrically controllable pretensioner based on longitudinal acceleration data, lateral acceleration data, vertical axis acceleration data, roll data, pitch data and yaw data.

14. The occupant restraint system of claim 12, further comprising
a third electrically controllable retractor having a third spool position sensor and a third electrically controllable pretensioner; said third electrically controllable retractor being fixed within said vehicle;
a fourth electrically controllable retractor having a fourth spool position sensor and a fourth electrically controllable pretensioner; said fourth electrically controllable retractor being fixed within said vehicle;
a second lap strap coupled to said third electrically controllable retractor and selectively engageable with said buckle; and,
a second shoulder strap coupled to said second electrically controllable retractor and selectively engageable with said buckle.

15. The occupant restraint system of claim 14, wherein said first, second, third and fourth electrically controllable pretensioners are a pyrotechnic pretensioner, a reversible electric pretensioner or both.

16. The occupant restraint system of claim 15, further comprising a headrest having a first motorized lateral support member and a second motorized lateral support member being actuatable by said microprocessor.

17. The occupant restraint system of claim 16, wherein said buckle further comprises a buckle sensor for detecting engagement of said lap strap and said shoulder strap; wherein said buckle sensor communicates said engagement of said lap strap and said shoulder strap with said microprocessor.

18. The occupant restraint system of claim 17, wherein said microprocessor determines a baseline position of said first electrically controllable retractor and said second electrically controllable retractor.

19. An occupant restraint system comprising;
a crash recognition module comprising a microprocessor and an inertial measurement unit;
a five point restraint mechanism sized to restrain an occupant;
a plurality of retractors coupled to said five point restraint system and in communication with said crash recognition module;
wherein said crash recognition module adjusts a retraction state of said plurality of retractors based on inertial data from said inertial measurement unit.

20. The occupant restraint system of claim 19, wherein retractors further comprise a pyrotechnic pretensioner, a reversible electric pretensioner or both.
